(19) United States
(12) Patent Application Publication
(10) Pub. No.: US 2014/0249973 A1
(43) Pub. Date: Sep. 4, 2014

(54) SYSTEM AND METHOD OF REVENUE CREATION AND ECONOMIC STIMULATION THAT PRESERVES A PROGRESSIVE TAX STRUCTURE AND UTILIZES INCENTIVES AND PENALTIES TO FORM THE BASIS OF TAXATION

(71) Applicant: Stephen Heier, Briarcliff, NY (US)

(72) Inventor: Stephen Heier, Briarcliff, NY (US)

(21) Appl. No.: 14/195,794

(22) Filed: Mar. 3, 2014

Related U.S. Application Data
(60) Provisional application No. 61/772,471, filed on Mar. 4, 2013.

(51) Int. Cl. G06Q 40/00

(52) U.S. Cl. CPC G06Q 40/10
USPC 705/31

(57) ABSTRACT

A system and method of revenue creation and economic stimulation that preserves a progressive tax structure and utilizes incentives and penalties to form the basis of taxation. One goal is to alter the saving and spending patterns of people in a manner beneficial to the economy, the individual, the government, and possibly targeted industries requiring remedial action or stimulation. Thus a predicted result is that economic productivity will increase employment, savings, and spending generation.

### CLAIM UNDER 35 U.S.C. 119(e)

This application claims the benefit under 35 U.S.C. 119(e) to U.S. Provisional Application No. 61/772,471, which has a filing date of Mar. 4, 2013.

### FIELD OF THE INVENTION

The present Invention relates to a system and method of taxation, more specifically, a system and method of taxation that positively reinforces consumer spending and negatively reinforces consumer savings. Furthermore, the Invention relates to a system and method of revenue creation and economic stimulation that preserves a progressive tax structure and utilizes incentives and/or penalties to form the basis of taxation.

### BACKGROUND OF THE INVENTION

There are many systems, methods, and theories of taxation that have been implemented and/or discussed throughout the world, and within the United States. Implementation of income tax dates back hundreds or even thousands of years. One of the first recorded taxes on income was the Saladin tithe introduced by Henry II in 1188 to raise money for the Third Crusade. In the U.S., an income tax was first instituted in 1862. A wealth tax is employed in various places such as in France whereby things you own, like cars and refrigerators, are taxed. The U.S. tax code is large and complex, with many special interests driving policy and tax legislation to favor certain industries over others, and certain sectors over others.

There is much political debate as to how to stimulate the economy, how to create wealth, how to create more jobs, how to increase consumer spending, how to increase investment in technology, how to increase social services and entitlements, how to provide or not provide health care, and how to lower the national debt. Different schools of thought follow classic political leanings One school of thought would have us lower taxes and decrease entitlements and government spending, the belief being that more money automatically translates to greater consumer spending, and that the free market will provide a safety net better than a large government bureaucracy.

Another school of thought would have us raise taxes and increase social services and government spending, the belief being that the free market will only look after a shrinking percentage of a privileged few at the expense of the many. Special interest groups push and pull the process, thus producing a patchwork of taxation that some perceive as often benefiting few.

Many lopsided economic policies spawn from a seemingly inflexible world view, with dogmatic application of asymmetric controls. For an economic policy as far reaching as a tax code to successfully achieve its goals and benefit the maximum number of people, however, the multiple components require simultaneous implementation.

At present any individual or family that earns income is required to pay income tax on monies earned (less deductions and exemptions). Some pay less. Some pay more. Some even pay nothing after deductions and exemptions. Income tax minimization is the goal of all, poor and rich, and some say the more money one makes, the more one is willing to spend to optimize one's tax position. The common wisdom is to save money regardless of income.

Such common wisdom is challenged by the Invention by implementing two simultaneous tax conditions, neither of which alone will produce the desired result. In this embodiment one condition involves income and one condition involves savings.

Firstly, income tax will be dramatically lowered, which will put more money into the taxpayer's pocket.

Secondly, savings above a threshold value or percentage of income shall be taxed at a variety of rates depending on income and the composition of expenses unique to that individual. Such two simultaneous tax conditions produce a push-pull effect which, when implemented together, will funnel more money into the taxpayer's pocket and increase the velocity of capital throughout the private sector economy via highly-motivated spending. By making formerly static capital more dynamic, economic stimulation may positively reinforce with a multiplier effect, and thus an economy will presumptively grow. This multiplier effect, realized as a recirculation of capital, may produce more net government revenue on the back end, having come from a larger future economy than larger revenue which would otherwise have come from higher income tax extracted from a smaller economy on the front end. The Invention challenges the notion that saving produces greater net income in the long run.

A question being posed is: Which produces more revenue for the government?
A) The revenue generated by a greater tax rate applied to a smaller collective income earlier in time; or
B) The revenue generated by a lesser tax rate applied to a larger collective income later in time+the taxable revenue generated by spending monies for goods and services that otherwise would have been parked in savings or more diffused investment instruments.
   This Invention is claiming that implementation of the latter will produce greater net income to the government and opportunity for greater net wealth to individuals.

Also, inflation can be effected and even possibly controlled through adjusting the parameters in the equations of this/these Invention(s) (the amount that can be saved with no taxation, or lower taxation, the amount of reduction of tax rate, the amount of penalty, the amount of inducement for various different types of expenditures,) which can allow for greater ability to stimulate the private sector economy in a multiplicity of directions depending on the momentary economic goals.

Finally, it should be noted that an individual household, in its simplest form, has three basic choices in allocating income: (i) expenses, including living expenses; (ii) discretionary spending; and (iii) savings. Investments can fall within the discretionary spending and/or savings choices of allocating income depending on the particulars, parameters, and specifics of such investments.

### DETAILED DESCRIPTION

The present Invention relates to a system and method of taxation, more specifically, a system and method of taxation that positively reinforces consumer spending and negatively reinforces consumer savings, thus reversing present wisdom. This method reduces a taxpayer's income tax, thus putting more disposable income in the taxpayer's hand while simultaneously increasing the taxation rate on savings above a base or threshold level, thus creating an incentive to spend. By altering the game theory of the tax code in this fundamental way, the economy, individual, government, and targeted industries requiring remedial action or stimulation all benefit on multiple levels. Thus there is a presumption that economic productivity will increase employment, savings, and spending.

In the following detailed description, numerous specific details are set forth in order to provide a thorough understanding of various aspects of one or more embodiments of the Invention. However, one or more embodiments of the Invention may be practiced without these specific details. In other instances, well-known methods, procedures, and/or components have not been described in detail so as not to unnecessarily obscure aspects of embodiments of the Invention.

A system and method of revenue creation and economic stimulation that preserves a progressive tax structure utilizing incentives and penalties forming the basis of a tax code is typically implementable by, but not limited to, a government upon people within its legal or economic jurisdiction, and, when implemented in this manor, can be called the “Tax Code Method”.

This system and method, which in part or in whole can be considered a Tax Code Method, will be applied to components of both income and net worth, where net worth may be composed of moneys, savings, investments of any financial instrument now known or unknown, real estate, art, intellectual property, or anything of value that can be converted to money and/or assets convertible through any number of transactions ultimately to money. One goal is to alter the saving and spending patterns of people in a manner beneficial to the economy, the individual, the government, and possibly targeted industries requiring remedial action or stimulation. Increasing spending in and into an economy can stimulate the economy itself causing increased economic productivity. Thus a predicted result is that economic productivity will increase employment, savings, and spending generation.

One current embodiment of this Invention comprises a system and method of revenue creation that preserves a progressive tax structure at a reduced rate, with a portion of income protected from taxation, and the remainder taxed at reduced rates. In this embodiment the taxation method provides incentives for low to middle income wage earners to augment or initiate savings by government-sponsored or other withholding for individual investment, and establishes penalties for what is deemed to be excessive savings above threshold(s) by upper income wage earners through taxation of monies (in whole or in part, and/or in excess of certain threshold(s), and/or meeting certain criteria) not spent on goods and/or services. The excess savings penalty incentivizes increased spending, providing stimulus to the economy and increasing the private sector tax base.

For example, increased spending on goods can engender increased productivity, and increased spending on goods and services can generate directly proportionate income for taxation, and both effects can reduce unemployment. Through this Method, it can be anticipated that, compared to other methods that employ only tax reduction, more monies will be spent on goods and services, with preservation of free markets, and with more individual discretionary control of where individuals spend their money. Additionally with strengthening and broadening of the private sector tax base, all government revenue for all programs can be maintained or enhanced, without necessitating an increase in the government workforce and pension obligations to staunch economic deterioration through employment unlikely to contribute to private sector productivity. Thus the productivity that is in the national interest can be encouraged by directing targeted consumer spending through savings credits that permit increased individual discretionary saving without penalty, and without reducing the individual tax paid as a result of an expanding economy.

The invention proposes to lower income tax and to tax excess saving. A taxpayer's income tax would not be eliminated, but would be reduced significantly, thus providing more money to spend on private sector consumption or investment. Income tax revenue would be defined in a basic form as R=K1(I), where:

R=income tax revenue to the government;

I=taxable income of an individual; and

K1=taxation rate for that individual.

In a general form, the income, I, would be composed of several components, and each would have its own corresponding taxation rate, or R=K1a(Ia)+K1b(Ib)+K1c(Ic)+ . . . , where:

K1a=the taxation rate applied to income component Ia;

K1b=the taxation rate applied to income component Ib;

K1c=the taxation rate applied to income component Ic, and so on.

In the basic form, and for simplicity, all the different K1 values are embodied in the representative form K1, and all the incomes from multiple sources are embodied in the representative form I.

A portion of individual savings, S, would not be taxed (Se=exempt savings) and the remaining portion of savings would be taxed (St=taxable savings) at a rate K2, where in its basic form S=Se+St, and taxable revenue to the government R2=K2(St).

In a general form, savings, S, would be composed of several components, and each taxable component would have its own corresponding taxation rate, or R2=K2a(Sta)+K2b(Stb)+K2c(Stc)+ . . . , where:

K2a=the taxation rate applied to taxable savings component Sta;

K2b=the taxation rate applied to taxable savings component Stb;

K2c=the taxation rate applied to taxable savings component Stc, and so on.

In the basic form, and for simplicity, all the different K2 values are embodied in the representative form K2, and all the taxable savings from multiple sources are embodied in the representative form St. This can create an incentive to spend money, and the natural effect can be to stimulate the private sector economy.

### DEFINITIONS

A “Progressive Tax” is a tax where the tax rate increases as the taxable base amount increases. The term “progressive” refers to the way the tax rate progresses from low to high, with the result that the average tax rate is less than the highest marginal tax rate. The term can be applied to individual taxes or to a tax system as a whole, applied to a year, multi-year, or lifetime. Progressive taxes are imposed in an attempt to reduce the tax of people with a lower ability-to-pay, as such taxes shift the incidence increasingly to those with a higher ability-to-pay. The term is frequently applied in reference to personal income taxes, where people with more income pay a higher percentage of that income in tax than do those with less income. It can also apply to adjustment of the tax base by using tax exemptions, tax credits, or selective taxation that creates progressive distribution effects.
“Taxpayer's Individual Situation” is the tax applied to the income and/or savings of an individual and/or household based on certain criteria which may include at least one of the following: income, savings, investments, deductions, and/or net worth.
“Entitlement Credit” is preferential weighting of at least one component of tax liability and/or reduction of at least one component of tax liability and/or a rebate of a certain amount towards at least one component of tax liability based on spending some amount or percentage of available money in some desired area.
A “Tax Code” is the system of laws and regulations regarding taxation, typically implementable by, but not limited to, a government upon people within its legal or economic jurisdiction.
“Tax Code Method” will be applied to components of taxation which may include at least one of the following: income, savings, and net worth.
“Net Worth” is the total assets minus the total liabilities of an individual or corporation. In personal finance, it refers to an individual's net economic position. The assets may be composed of moneys, savings, investments of any financial instrument now known or unknown, real estate, art, intellectual property and/or anything of value that can be converted to money.
“Recirculation” of capital is the number of times money changes hands, from transaction to transaction.
“Velocity of Capital” is the number of times a quantity of money changes hands per unit of time.

### SUMMARY OF THE INVENTION

A system and method of revenue creation and/or economic stimulus utilizing at least one of incentive(s) and/or penalty(ies) comprising higher taxation of savings, and/or lower taxation of income spent on goods and/or services. This can further comprise a reduction of the base income tax rate. The criterion or criteria for a reduction of base income tax rate can be in part or in whole, specific to the Taxpayer's Individual Situation. Higher taxation of savings can initiate at a threshold value where the threshold value is defined by and/or initiated at at least one hard or soft threshold breakpoint. A hard or soft threshold breakpoint or breakpoints can be adjustable. There can be many hard and/or soft threshold breakpoints. Taxation of savings can occur above a threshold value which can be a hard or soft threshold breakpoint and the taxation of savings below this threshold value which can be a hard or soft threshold breakpoint can be zero. The higher taxation of savings can initiate at the threshold value and this threshold value may be defined by at least one mathematical equation. The percentage or amount of taxation can be further based upon the type of spending. The type of spending may alter and/or redefine parameters in at least one mathematical equation defining how savings is taxed. The type of spending can alter and/or redefine the parameters in a mathematical equation defining the percentage or amount of taxation. The type of spending may alter and/or redefine the parameters in at least one mathematical equation and a hard or soft threshold breakpoint at which taxation of savings occurs above the hard or soft threshold breakpoint and taxation of savings below the hard or soft threshold breakpoint can be zero. The awarding of Entitlement Credit can be earned by use of a spending formula. This Entitlement Credit award earned can further be dependant upon the type of spending. There can be an alteration or allocation of the composition of savings which is in whole or in part between liquid and material assets which further may alter or redefine parameters in at least one mathematical equation and/or the savings threshold and/or penalty associated with the types of savings and/or assets. An effect of this alternation can be to not cause uncontrolled Inflation in whole or in part, as the same amount of money can be sequestered after a defined recirculation of money in the economy. Inflation can be controlled through adjusting the parameters in at least one predetermined equation (amount that can be saved with no taxation, tax rate, penalty, amount of inducement for various types of expenditures), which may allow the ability to stimulate the economy in a direction wanted to achieve targeted goals.

Further, another embodiment of this Invention comprises a system and method by which a change in rate is gradually phased in wherein three regimes are defined as follows:

Regime 1 is defined as the region in which a lower rate is charged and/or paid below a lower threshold breakpoint;

Regime 2 is defined as the region in which a transitional rate is gradually phased in whereby this transitional rate changes from the lower rate corresponding to the lower threshold breakpoint to an upper rate corresponding to an upper threshold breakpoint, and the transitional rate does not affect monies paid within regime 1;

Regime 3 is defined as the region in which an upper rate is charged and/or paid above an upper threshold breakpoint, and an upper rate does not affect the monies paid within either regime 1 or regime 2.

Another embodiment of the Invention comprises a system and method by which an entitlement is gradually phased out as income increases. This could be applied to benefits including, but not limited to, unemployment insurance, disability, health benefits, welfare, housing, and/or food stamps. In such an application, the entire benefit is not lost if the income condition upon which the benefit is based changes for the better. For instance, if a person is receiving disability benefits because he cannot work for any number of reasons but can later handle a certain amount of part time employment, the entire benefit is not summarily lost if entitlements have a gradual phase out because the person is capable of doing some work. In this case, the benefit would diminish gradually, and disappear if the person can wean himself back to full time employment at a certain income level. Philosophically, this can be applied to many benefit related programs, and incentives are to return to work rather than to remain disabled and/or unemployed.

Another embodiment comprises a system and method by which the revenue generated by a lesser tax rate applied later in time to a larger collective income or tax base, plus the taxable revenue generated by spending greater monies for goods and services by that greater tax base, produces greater net income than that generated by a greater tax rate applied earlier in time to a lesser collective income or tax base, plus the taxable revenue generated by spending lesser monies for goods and services by that lesser tax base.

### BENEFITS AND KEY POINTS OF THE SYSTEM AND METHOD

This Invention will benefit the collective by restructuring the spending and savings patterns of millions of people.

Following are some objects and goals of this System and Method:
1. To cut taxes;
2. To stimulate economic productivity;
3. To decrease unemployment;
4. To continue to increase and/or maintain personal wealth and savings;
5. To increase potential government revenue available to finance important endeavors;
6. To increase potential government revenue available to support endeavors of national or global importance; and
7. To increase the tax base by increasing productivity and creating higher employment and need to employ more people.

### BRIEF DESCRIPTION OF DRAWINGS

FIG. 1 is a chart showing one upper income example comparing a possible higher tax rate representative of the present tax structure with at least one embodiment of the system and method that exemplifies a lower tax structure with imposed spending and lesser savings.

FIG. 2 is a chart showing one lower income example comparing a possible higher tax rate representative of the present tax structure with at least one embodiment of the system and method that exemplifies a lower tax structure with greater spending and/or savings.

FIG. 3 is a chart showing a second upper income example comparing a possible higher tax rate representative of the present tax structure with at least one embodiment of the system and method that exemplifies a lower tax structure with imposed spending and the same savings.

### DETAILED DESCRIPTION OF DRAWINGS

In the following description of drawings, reference is made to the accompanying drawings/figures that form a part hereof, as well as those within the body herein, and in which is shown, by way of illustration, a specific embodiment(s) in which the Invention may be practiced. It is to be understood that other embodiments may be utilized and structural changes may be made without departing from the scope of the present Invention.

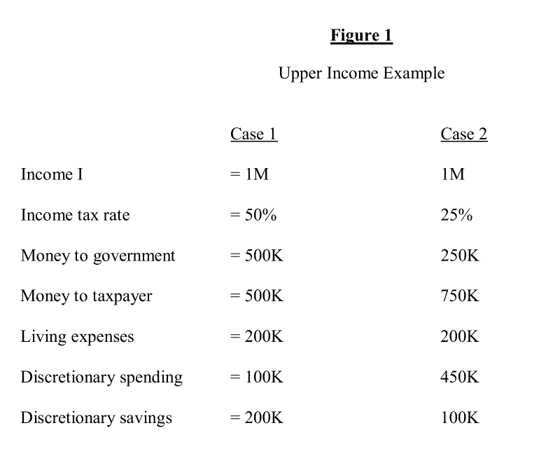

The following simplified comparative examples are illustrative of taxation and spending shifts for different income levels (where M=$1,000,000 and K=$1,000).
FIG. 1 is a chart showing one upper income example comparing Case 1, which is a possible higher tax rate representative of the present tax structure, with Case 2, which is at least one embodiment of the system and method that exemplifies a lower tax structure with imposed spending and lesser savings.
Higher income example: Income=1M/year
This compares a 50% income tax in Case 1 with a 25% income tax in Case 2.
Case 1 leaves the individual with 500K after taxes, with 500K going to the government.
Case 2 leaves the individual with 750K after taxes, with 250K going to the government.
Living expenses are the same 200K in both cases.
The discretionary savings drops from 200K in Case 1 to 100K in Case 2, however the discretionary spending increases from 100K in Case 1 to 450K in Case 2. This places 350K directly into the economy of goods and services at the expense of 100K in extra savings deemed to be “excessive”. This imposed spending is at the discretion of the individual, but it remains in the private sector, directly stimulating the purchase of goods and services.

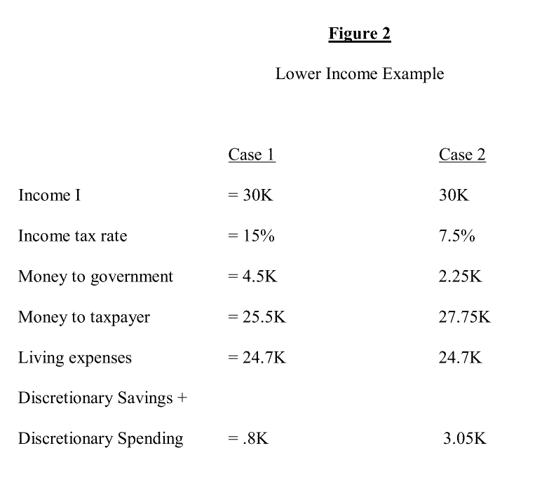

In this example using this system and method being implemented in Case 2, the objectives achieved are that the taxes are cut (reduced 50%) and spending is increased by the total amount saved in taxes (in this case $250K) plus $100K that would otherwise have gone into savings but is considered excessive in this model (This is arbitrary and for illustrative purposes only, but it demonstrates the principle). The savings continues to build even with the lower savings cap. The additional discretionary spending further produces economic stimulus, which can lead to increased employment, allow for further financial investment and endeavors that equally stimulate the economy. The result on government taxation is that while the individual contribution decreases initially, this will be more than made up for in tax revenue derived from recirculation of the added money in the economy and potentially opening doors to increased employment and associated increase in the tax base.
FIG. 2 is a chart showing one lower income example comparing Case 1, which is a possible higher tax rate representative of the present tax structure, with Case 2, which is at least one embodiment of the system and method that exemplifies a lower tax structure with greater spending and/or spending.
Lower income example: Income=30K/year
This compares a 15% income tax in Case 1 with a 7.5% income tax in Case 2.
Case 1 leaves the individual with 25.5K after taxes, with 4.5K going to the government.
Case 2 leaves the individual with 27.75K after taxes, with 2.25K going to the government.
Living expenses are the same 24.7K in both cases.
The 0.8K discretionary savings and/or discretionary spending in Case 1 raises to 3.05K in Case 2, thus putting an extra $2,250 in the taxpayer's pocket. The individual may choose to either save money or to spend a portion of this on goods and services to increase personal quality of life, and in Case 2 there is more money to do so with. As with FIG. 1, this money also feeds the private sector economy with goods and services.

In this example using this system and method being implemented in Case 2, the objectives achieved are that the taxes are cut (reduced by 50% to 7.5%) and spending is increased by the total amount saved in taxes (in this case $2,250). At the lower income level, the system and method demonstrates a win win scenario in that both savings and discretionary income to spend increases for that individual or household while the system and method still produces economic spending, economic stimulus, and tax revenue derived from recirculated money in the economy.

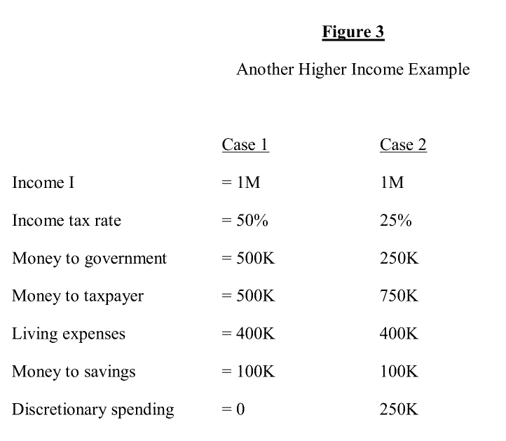

This model presents a scenario where the penalty threshold, whether hard or soft, can be adjusted to not affect individuals or households below a certain income. And further, a taxpayer's specific composition of net worth and/or other factors can determine the penalty threshold.
FIG. 3 is a chart showing a second upper income example comparing Case 1, which is a possible higher tax rate representative of the present tax structure, with Case 2, which is at least one embodiment of the system and method that exemplifies a lower tax structure with imposed spending and the same savings.
Another higher income example: Income=1M/year
Again this compares a 50% income tax in Case 1 with a 25% income tax in Case 2.
Case 1 leaves the individual with 500K after taxes, with 500K going to the government.
Case 2 leaves the individual with 750K after taxes, with 250K going to the government.
Living expenses are the same 400K in both cases.
The discretionary savings remains the same 100K in both cases, however the discretionary spending increases from 0 in Case 1 to 250K in Case 2. This places 250K directly into the economy of goods and services while savings remains constant. If the taxpayer were to place the 250K into savings, he forfeits all that back to the government (taxed at 100%), thus defaulting to the tax strategy of Case 1 (R2=K2(St), or 250K=100%(250K)), where:
R2=tax revenue to government
K2=tax rate on taxable savings
St=taxable savings

If, on the other hand, the 250K is spent on goods and services, the money enters the market, thus stimulating the private sector economy, with the added benefit that the taxpayer gets to keep what he purchased and he derives the benefit of more spendable income, or an implied greater income under the taxation system of Case 1. The incentive is therefore to spend money buying goods or services. A portion of the 250K initially lost by the government is recovered in immediate sales tax and resale tax as a result of recirculation of money and secondary spending by others and the future derived benefit of a growing economy for the future. So present income to the government is invested into a future capable of yielding more than what could have been accrued in Case 1.

In this example using this system and method being implemented in Case 2, the objectives achieved are that the taxes are cut (reduced 50%) and spending is increased by the total amount saved in taxes (in this case $250K). The savings remains the same $100K in both Cases, but the discretionary spending raises to $250K, and this would otherwise have gone directly to the government.

The additional discretionary spending produces economic stimulus, which can lead to increased employment, allow for further financial investment and endeavors that equally stimulate the economy. The result on government taxation is that while the individual contribution decreases initially, this will be more than made up for in tax revenue derived from recirculation of the added money in the economy and potentially opening doors to increased employment and associated increase in the tax base.

Another variation of this example would be where K2, the tax rate on taxable saving, (where tax revenue to the government R2=K2(St)) equals some rate less than 100%, thus enabling the taxpayer to save more than 100K, and the government gets more money up front in exchange for an increasing total taxation rate.
* In all three Figures (examples) all monies shown allocated as discretionary spending could be subject to an additional minimum tax so then for example in FIG. 3 the $250,000 of discretionary spending in Case 2 would not be 100% available for use by the taxpayer if there was an additional minimum tax on all monies to be used for discretionary spending.

### PRESENTATION OF HARD THRESHOLD VS. SOFT THRESHOLD AS THEY MAY AFFECT THE SYSTEM AND METHOD

### EXAMPLE 1

### Hard Threshold Breakpoint

A hard threshold breakpoint defines an abrupt change in taxation rate. The following example illustrates this, where
R=revenue due to taxation
I=income
Iht=income hard threshold (in this example $200,000)
K=general taxation rate
R=tax revenue
Taxation rate below income Iht=Khtlow (in this example 30%)
Taxation rate above income Iht=Khthigh (in this example 40%)
Therefore, below $200,000, R=IKhtlow
Above $200,000, R=IKhthigh
So taxation for the following income levels is as follows

| Income | taxation rate | revenue | what you keep |
|---|---|---|---|
| $150,000 | 30% | $45,000 | $105,000 |
| $200,000 | 30% | $60,000 | $140,000 |
| $200,001 | 40% | $80,000.40 | $120,000.60 |
| $233,333.33 | 40% | $93,333.33 | $140,000 |
| $250,000 | 40% | $100,000 | $150,000 |
| $300,000 | 40% | $120,000 | $180,000 |

Note that in the case of hard thresholds, there is an abrupt loss of income at any income immediately over the hard threshold. In the above example, when income goes up only one dollar above the hard threshold, there is an immediate income loss of $20,000, and it takes an additional $33,333.33 of income to keep more than the $140,000 you kept at a $200,000 income. While this is a sterile example, it demonstrates that hard threshold-based programs can cause all benefits to be lost above a threshold income, including but not limited to health benefits, housing, welfare, and disability, to name a few. Programs based on hard thresholds can diminish the incentive to thrive and can inspire the gaming of systems in the direction of remaining disabled or remaining on welfare because there can be an immediate loss of everything rather than a gradual phasing in process as in the soft threshold defined as follows.

### EXAMPLE 2

### Soft Threshold Breakpoint

Trl=taxation rate low
Trh=taxation rate high
I=income
Itl=income threshold low
Ith=income threshold high
R=revenue due to taxation
K=general taxation rate
I=income
Ist=soft threshold income
Istl=income soft threshold low (in this example $200,000)
Taxation rate below income Istl=Kstlow (in this example 30%)
Isth=income threshold high (in this example $300,000)
Taxation rate above income Isth=Ksthigh (in this example 40%)
Thus, there are three piecewise regimes defined as:

Regime 1
Income below Istl, or $200,000 is taxed at Kstlow, or 30%
R=IKstlow

Regime 2
Transitional region where there is a gradual and linear increase in rate between the low threshold and the high threshold income, or the rate goes from 30% at $200,000 to 40% at $300,000, or alternatively defined as the income going from 30% to 40% over the next $100,000 of income above $200,000, thus making the average rate equal to 35% over the income transition range while not affecting the taxation rate below 30%. Mathematically stated:

R=Istl Kstlow+(Kstlow+((Ksthigh−Kstlow)/2)((I−Istl)/(Isth−Istl)))(I−Istl)
Note the factor of 2 in the above equation, and this is necessary because we are integrating the area under the linear transition between one tax rate and another, effectively reducing to the area of a triangle, where the base of the triangle is $100,000 and the height of the triangle is the difference between 40% and 30%. Without the factor of 2, for incomes greater than $300,000 this would reduce to a hard threshold transition from 30% to 40% at $200,000

Regime 3
Income above Isth, or $300,000 is taxed at Ksthigh, or 40%

R=Istl Kstlow+(Kstlow+((Ksthigh−Kstlow)/2))(Isth−Istl)+(I−Isth)Ksthigh

| Income | taxation rate | revenue | what you keep |
|---|---|---|---|
| $150,000 | 30% | $45,000 | $105,000 |
| $200,000 | 30% | $60,000 | $140,000 |

transitional rate*

| | | | |
|---|---|---|---|
| $200,001 | 30.00005% | $60,000.30 | $140,000.70 |
| $250,000 | 32.5% | $76,250 | $173,750 |
| $300,000 | 35% | $95,000 | $205,000 |

taxation rate

| | | | | |
|---|---|---|---|---|
| $350,000 | 40% | (on $50k) | $115,000 | $235,000 |
| $400,000 | 40% | (on $100k) | $135,000 | $265,000 |

*Note that the transitional rate only applies to the transitional region between $200,000 and $300,000, and the maximum tax for this $100,000 regime is 35%.

The foregoing description and specification of at least one current preferred embodiment of the Invention has been presented for the purposes of illustration and description. While multiple embodiments are disclosed, still other embodiments of the present Invention will become apparent to those skilled in the art from this application, which shows and describes illustrative embodiments of the Invention. As will be realized, the Invention is capable of modifications in various obvious aspects, all without departing from the spirit and scope of the present Invention. Accordingly, the detailed description is to be regarded as illustrative in nature and not restrictive. Also, although not explicitly recited, one or more embodiments of the Invention may be practiced in combination or conjunction with one another. Furthermore, the reference or non-reference to a particular embodiment of the Invention shall not be interpreted to limit the scope the Invention. It is intended that the scope of the Invention not be limited by any section herein, nor by the specific claims and the equivalents drafted herein.

What is claimed:

1. A system and method of revenue creation and/or economic stimulus utilizing at least one of incentive(s) and/or penalty(ies) comprising of the following:
A) higher taxation of savings; and/or
B) lower taxation of income spent on goods and/or services.

2. The system and method of claim 1 further comprising reduction of the base income tax rate.

3. The system and method of claim 2, wherein the criteria for said reduction is in part or in whole, specific to the Taxpayer's Individual Situation.

4. The system and method of claim 1, wherein said higher taxation of savings initiates at a threshold value where said threshold value is defined by and/or initiated at at least one hard or soft threshold breakpoint.

5. The system and method of claim 4 wherein said at least one hard or soft threshold breakpoint is adjustable.

6. The system and method of claim 4 wherein there are many hard and/or soft threshold breakpoints.

7. The system and method of claim 4, wherein said taxation of savings occurs above said threshold value which is a hard or soft threshold breakpoint and said taxation of savings below said threshold value which is a hard or soft threshold breakpoint is zero.

8. The system and method of claim 4 wherein said higher taxation of savings that initiates at said threshold value where said threshold value is defined by at least one mathematical equation.

9. The system and method of claim 3, further comprising of the percentage or amount of taxation being further based upon the type of spending.

10. The system and method of claim 9, wherein said type of spending alters and/or redefines parameters in at least one mathematical equation defining how savings is taxed.

11. The system and method of claim 9, wherein said type of spending alters and/or redefines said parameters in a mathematical equation defining the percentage or amount of taxation.

12. The system and method of claim 10, wherein said type of spending alters and/or redefines said parameters in said at least one mathematical equation and a hard or soft threshold breakpoint at which taxation of savings occurs above said hard or soft threshold breakpoint and said taxation of savings below said hard or soft threshold breakpoint is zero.

13. The system and method of claim 9, further comprising the step of awarding Entitlement Credit earned by use of a formula using at least one said type of spending as a variable.

14. The system and method of claim 13, wherein said Entitlement Credit award earned is further dependant upon said type of spending.

15. The system and method of claim 4, wherein there is an alteration or allocation of the composition of savings which is in whole or in part between liquid and material assets which further may alter or redefine parameters in at least one mathematical equation and/or the savings said threshold and/or penalty associated with the types of savings and/or assets.

16. The system and method of claim 15, wherein an effect of said alternation will not cause uncontrolled Inflation in whole or in part, and additional money can be collected after recirculation.

17. The system and method of claim 16 wherein inflation can be controlled, adjusted, and/or affected through adjusting the parameters in at least one mathematical equation (amount that can be saved with no taxation, tax rate, penalty, amount of inducement for various types of expenditures) which allows for the ability to stimulate and/or manipulate the economy in whole or in part.

18. A system and method by which a change in rate of percentage of money paid to a second party is gradually phased in wherein three regimes are defined as follows:
Regime 1 is defined as the region in which a lower rate is charged and/or paid below a lower threshold breakpoint;
Regime 2 is defined as the region in which a transitional rate is gradually phased in whereby said transitional rate changes from said lower rate corresponding to said lower threshold breakpoint to an upper rate corresponding to an upper threshold breakpoint, and said transitional rate does not affect monies paid within said regime 1;
Regime 3 is defined as the region in which said upper rate is charged and/or paid above a said upper threshold breakpoint, and said upper rate does not affect the monies paid within either said regime 1 or said regime 2.

19. A system and method by which an entitlement is gradually phased out as income increases.

20. The system and method of claim 1 wherein the revenue generated by a lesser tax rate applied later in time to a larger collective income plus the taxable revenue generated by spending greater monies for goods and services produces greater net income than that generated by a greater tax rate applied earlier in time to a lesser collective income plus the taxable revenue generated by spending lesser monies for goods and services.
